(19) United States
(12) Patent Application Publication
(10) Pub. No.: US 2014/0083805 A1
(43) Pub. Date: Mar. 27, 2014

(54) DISC BRAKE CALIPER, BRAKE PADS AND PAD PIN

(71) Applicant: Shinya HIROTOMI, Osaka (JP)

(72) Inventor: Shinya HIROTOMI, Osaka (JP)

(73) Assignee: SHIMANO INC., Osaka (JP)

(21) Appl. No.: 13/628,708

(22) Filed: Sep. 27, 2012

(51) Int. Cl. F16D 65/095; F16D 65/092; B62L 1/00

(52) U.S. Cl. 188/73.31; 188/251 R; 188/234

(57) ABSTRACT

A disc brake caliper is provided that basically comprises a caliper housing, a disc brake pad pin, at least one disc brake pad and a thermally insulating material. The caliper housing defines a brake rotor receiving slot and a first pin receiving opening. The disc brake pad pin is disposed in the first pin receiving opening. The at least one disc brake pad is disposed in the brake rotor receiving slot and movably supported on the disc brake pad pin which extends through a pin mounting opening in the at least one disc brake pad. The thermally insulating material is disposed in at least one of the first pin receiving opening of the caliper housing and the pin mounting opening of the at least one disc brake pad.

### BACKGROUND

1. Field of the Invention

This invention generally relates to a disc brake caliper and its parts. More specifically, the present invention relates to a disc brake caliper that is provided with thermally insulated material to decrease the heat transfer from the brake pads to the caliper housing.

2. Background Information

In recent years, certain high performance bicycles have included disc brakes. Disc brake systems provide a substantial braking power in relationship to the amount of braking force applied to the brake lever. Also, disc brake systems typically provide a high level of consistency in all types of weather and riding conditions. Disc brake systems typically include a caliper housing and a pair of brake pads. The brake pads are movably mounted to the caliper housing by a pad pin or axle. Disc brakes can be hydraulically actuated or mechanically actuated for moving the movable brake pad(s). The caliper housing is attached to the front or back wheel of a bicycle such that brake pads are positioned on either side of a rotor. During braking, the brake pads are pressed against opposite sides of a brake rotor that is fixed to the wheel to slow down or stop the rotation of the disc, and thus, slow down or stop the rotation of the wheel. While the brake pads contact the brake rotor, friction occurs between the brake pads and the brake rotor. At that time, the brake pads and brake rotor become very hot. The heat in the brake pads is transferred to the caliper housing.

### SUMMARY

It has been found that the heat in the brake pads is basically transferred to the caliper housing in two thermal transfer routes. The first thermal transfer route is from the brake pads through the pistons to the caliper housing, and the second thermal transfer route is from the brake pads through the brake pad pin to the caliper housing. Generally, the present disclosure is directed to suppressing the heat transfer from the brake pads to the caliper housing by the second thermal transfer route.

In accordance with a first aspect presented by this disclosure, a disc brake caliper is provided that basically comprises a caliper housing, a disc brake pad pin, at least one disc brake pad and a thermally insulating material. The caliper housing defines a brake rotor receiving slot and a first pin receiving opening. The disc brake pad pin is disposed in the first pin receiving opening. The at least one disc brake pad is disposed in the brake rotor receiving slot and movably supported on the disc brake pad pin which extends through a pin mounting opening in the at least one disc brake pad. The thermally insulating material is disposed in at least one of the first pin receiving opening of the caliper housing and the pin mounting opening of the at least one disc brake pad.

In accordance with a second aspect presented by this disclosure, a disc brake pad is provided that basically comprises a mounting plate, a friction pad and a thermally insulating material. The mounting plate has a pin mounting opening. The friction pad is fixedly attached to the mounting plate. The thermally insulating material is attached to an inner surface defining the pin mounting opening.

In accordance with a third aspect presented by this disclosure, a disc brake pad pin for supporting a disc brake pad is provided that basically comprises an elongated rod and a thermally insulating material. The elongated rod has an outer peripheral surface. The thermally insulating material is attached to the outer peripheral surface of the elongated rod.

In accordance with a fourth aspect presented by this disclosure, a disc brake pad pin for supporting a disc brake pad is provided that basically comprises a head portion, and an elongated rod portion made of a thermally insulating material.

In accordance with a fifth aspect presented by this disclosure, a disc brake caliper housing is provided that basically comprises a caliper housing and a thermally insulating material. The caliper housing defines a first pin receiving opening. The thermally insulating material is attached to an inner surface defining the first pin receiving opening.

### BRIEF DESCRIPTION OF THE DRAWINGS

Referring now to the attached drawings which form a part of this original disclosure:

FIG. 1 is a perspective view of a disc brake caliper that is designed to limit the heat transfer from the brake pads to the caliper housing via the pad pin in accordance with one embodiment;

FIG. 2 is an exploded perspective view of the disc brake caliper illustrated in FIG. 1;

FIG. 3 is a cross sectional view of the disc brake caliper illustrated in FIGS. 1 and 2 as seen along section line 3-3 of FIG. 1;

FIG. 4 is a perspective view of one of the brake pads that is used in the disc brake caliper illustrated in FIGS. 1 to 3;

FIG. 5 is a perspective view of the pad pin that is used in the disc brake caliper illustrated in FIGS. 1 to 3;

FIG. 6 is an exploded perspective view of the pad pin illustrated in FIG. 5;

FIG. 7 is a perspective view of a modified pad pin that is used in the disc brake caliper illustrated in FIGS. 1 to 3; and

FIG. 8 is a cross sectional view of the modified pad pin as seen along section line 8-8 of FIG. 7.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

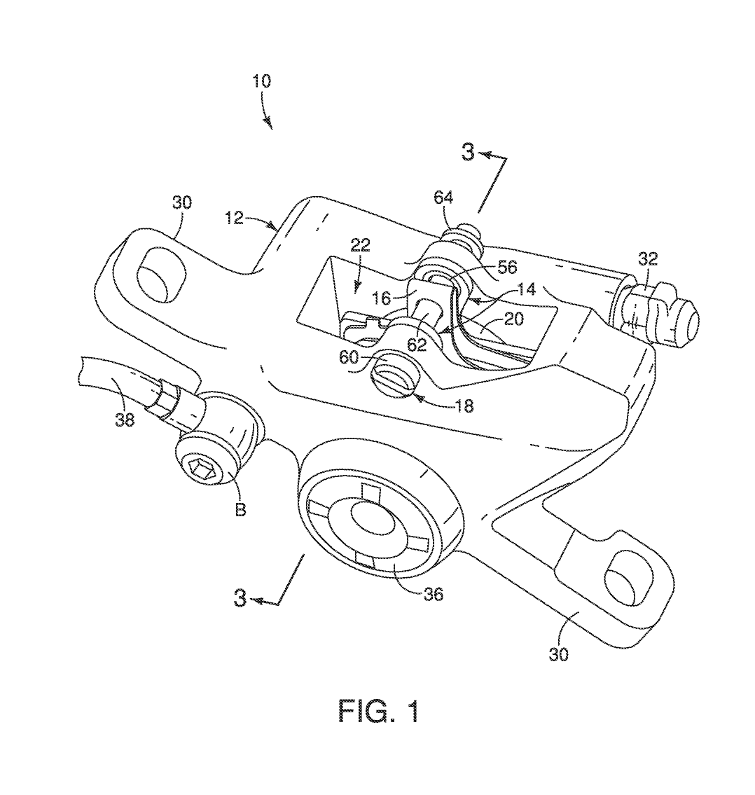

Referring initially to FIGS. 1 to 3, a disc brake caliper 10 is illustrated in accordance with one illustrative embodiment. The disc brake caliper 10 is mounted to a portion of a bicycle to engage a brake rotor (not shown) in a conventional manner. The disc brake caliper 10 basically includes a caliper housing 12, a pair of brake pads 14, a biasing member 16, a brake pad pin 18 and a pair of pistons 20. As explained later, the disc brake caliper 10 is configured to suppress the heat transfer from the brake pads 14 to the caliper housing 12 by a thermal transfer route that extends from the brake pads 14 through the brake pad pin 18 to the caliper housing 12. This is generally accomplished by providing a thermally insulating material in the thermal transfer route that extends from the brake pads 14 through the brake pad pin 18 to the caliper housing 12.

The caliper housing 12 defines a brake rotor receiving slot 22. In the illustrated embodiment, the disc brake caliper 10 is a hydraulically operated disc brake caliper that is fluidly connected to a hydraulic brake lever (not shown) in a conventional manner. However, the arrangements used for limiting heat transfer from the brake pads 14 to the caliper housing 12, as discussed below, can be used in a mechanically (cable) operated disc brake caliper.

Accordingly, in the illustrated embodiment, the pistons 20 are movably mounted in the caliper housing 12 in a conventional manner. The pistons 20 are biased away from each other by the biasing member 16, which presses the brake pads 14 outwardly against the pistons 20. The pistons 20 are moved together due to the pressure of the hydraulic fluid acting on the pistons 20 as a result of a user squeezing a hydraulic brake lever that is fluidly connected to the caliper housing 12.

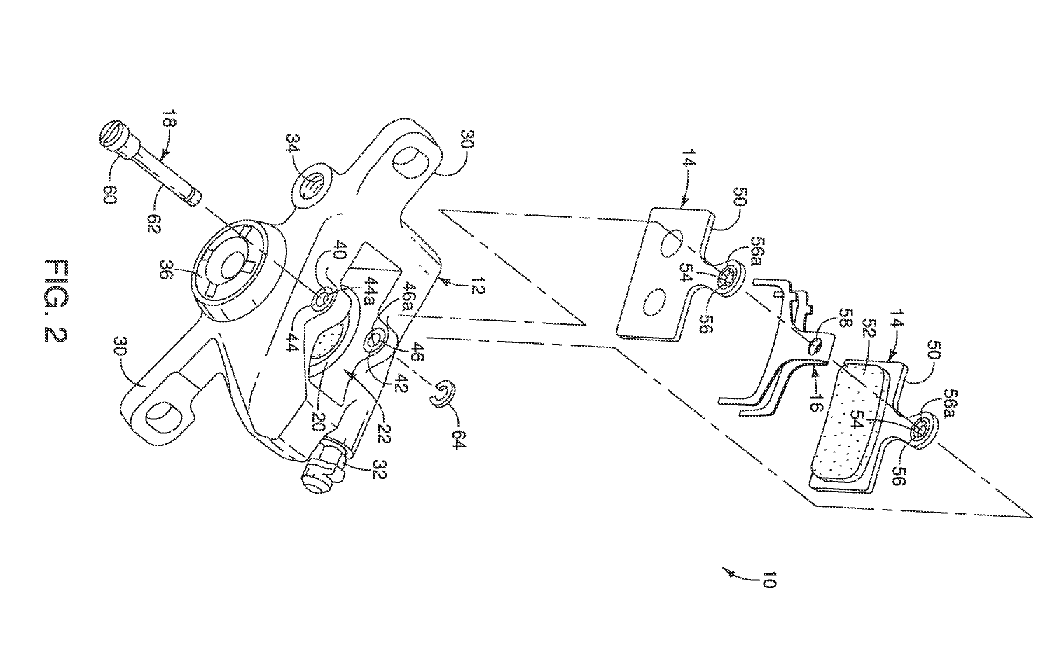

In the illustrated embodiment, the caliper housing 12 is a one-piece member made of forged aluminum that is machined to the final product. Of course, the caliper housing 12 can be two parts that are attached together by bolts, or any other suitable configuration. Also the material of the caliper housing 12 is not limited to aluminum, but can be any material that is a suitable heat resistant material that can withstand the heat generated during braking. In the illustrated embodiment, the caliper housing 12 basically has a pair of mounting flanges 30 for mounting to a portion of a bicycle using a pair of fixing bolts (not shown) in a conventional manner. A bleed nipple 32 is screwed into a threaded port of the caliper housing 12 for draining the hydraulic fluid (e.g., mineral oil) from the hydraulic passages formed inside the caliper housing 12. As best seen in FIGS. 1 and 2, the caliper housing 12 also has a hydraulic inlet port 34 that receives a banjo bolt B for fluidly connecting a hydraulic line 38 to the hydraulic inlet port 34. A cylinder plug 36 is inserted into an opening of the caliper housing 12.

The caliper housing 12 further includes a first pin receiving opening 40 and a second pin receiving opening 42. The centers of the first and second pin receiving openings 40 and 42 are axially aligned for receiving the disc brake pad pin 18. In this way, the caliper housing 12 supports the disc brake pad pin 18.

The first pin receiving opening 40 is coated or laminated with a layer of thermally insulating material 44 in the form of a cylindrical tube. In other words, the thermally insulating material 44 is fixedly attached an inner surface defining the first pin receiving opening 40 of the caliper housing 12. The thermally insulating material 44 is made of a resin material such as an epoxy resin.

Preferably, the second pin receiving opening 42 is also coated or laminated with a layer of thermally insulating material 46 in the form of a cylindrical tube. In other words, the thermally insulating material 46 is fixedly attached to an inner surface defining the second pin receiving opening 42 of the caliper housing 12. The thermally insulating material 46 is made of a resin material such as an epoxy resin.

While the inner surfaces of the first and second pin receiving openings 40 and 42 are illustrated as cylindrical, the inner surfaces of the first and second pin receiving openings 40 and 42 can have other configurations as needed and/or desired. For example, one or both of the inner surfaces of the first and second pin receiving openings 40 and 42 can be form as a polygonal tube, or can be uneven in the axial direction. The thermally insulating material 44 has an inner surface 44a that contacts the brake pad pin 18, and the thermally insulating material 46 has an inner surface 46a that contacts the brake pad pin 18. However, the heat transfer from the brake pad pin 18 to the caliper housing 12 is suppressed by the thermally insulating materials 44 and 46, which thermally insulate the caliper housing 12 from the heat in the brake pad pin 18.

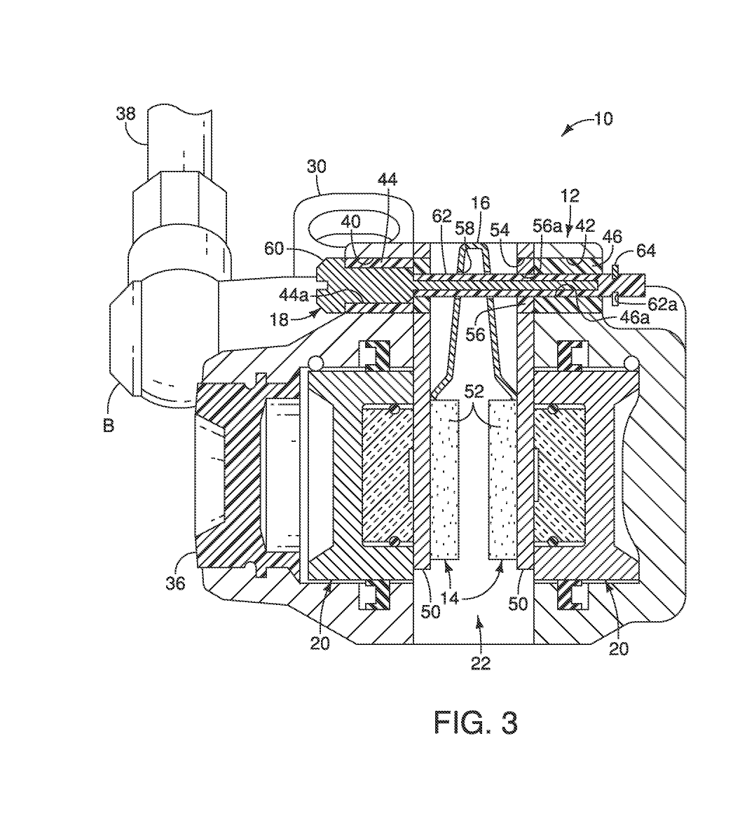

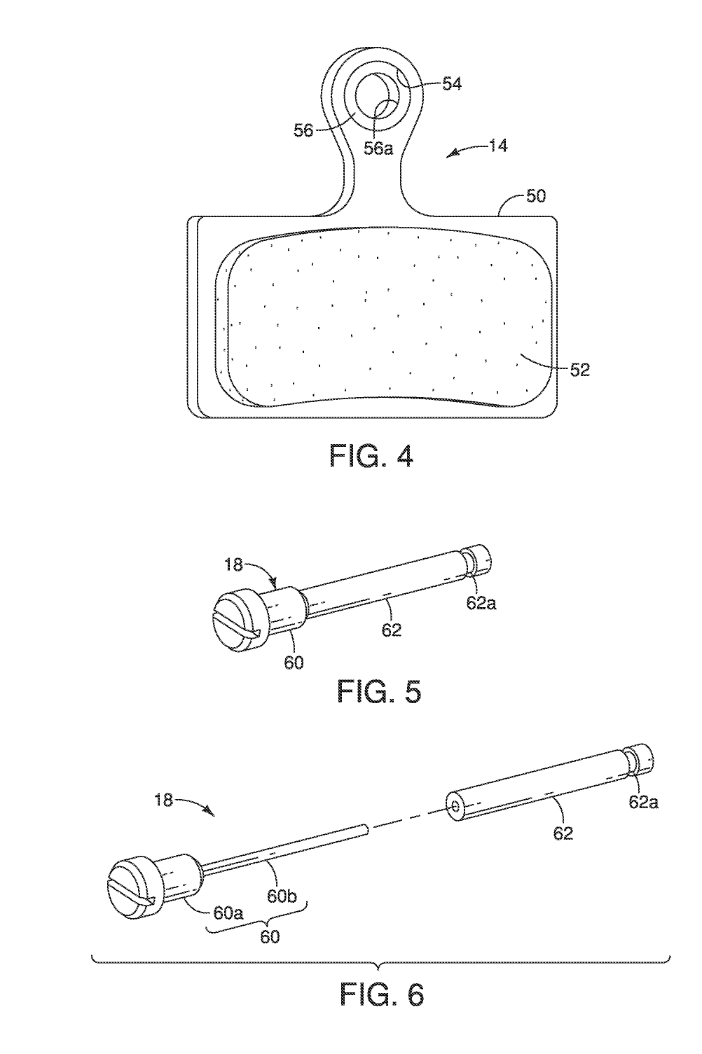

In the illustrated embodiment, as seen in FIGS. 2 and 3, the brake pads 14 are identical, but face in different directions when installed on the disc brake pad pin 18 as explained below. Thus, the same reference numerals will be used for each of the brake pads 14. Referring to FIG. 4, each of the brake pads 14 basically includes a mounting plate 50 and a friction pad 52. The friction pad 52 is fixedly attached to the mounting plate 50 in a conventional manner (e.g., two rivets). The mounting plate 50 is a metal plate that is made of a stainless steel or any other suitable material for a mounting plate of a brake pad. The mounting plate 50 has a pin mounting opening 54. As seen in FIG. 3, the brake pads 14 are disposed in the brake rotor receiving slot 22 and movably supported on the disc brake pad pin 18, which extends through the pin mounting openings 54 in the brake pads 14.

As seen in FIGS. 3 and 4, each of the brake pads 14 includes a layer of thermally insulating material 56 forming a ring shaped member that is inside each of the pin mounting openings 54. In other words, the thermally insulating material 56 is fixedly attached to an inner surface that defines the pin mounting opening 54. The thermally insulating material 56 is made of a resin material such as an epoxy resin. While the inner surface of the pin mounting opening 54 and the outer surface of the thermally insulating material 56 are illustrated as being cylindrical, it will be apparent from this disclosure that the inner surface of the pin mounting opening 54 and the outer surface of the thermally insulating material 56 can have other mating types of configurations. Each of the thermally insulating material 56 has an inner surface 56a that contacts the brake pad pin 18. However, the heat transfer from the brake pads 14 to the brake pad pin 18 is suppressed by the thermally insulating materials 56, which thermally insulate the brake pad pin 18 from the heat in the brake pads 14. Thus, the heat transfer from the brake pads 14 to the caliper housing 12 is also suppressed by the thermally insulating materials 56.

As seen in FIGS. 2 and 3, the biasing member 16 is a metal spring. The biasing member 16 is disposed between the brake pads 14 for biasing the brake pads 14 out of engagement with the disc brake rotor in a conventional manner. The biasing member 16 has a pair of openings 58 for receiving the brake pad pin 18. Since the biasing member 16 is a conventional part, the biasing member 16 will not be discussed in further detail herein. Moreover, the biasing member 16 is not limited to the one illustrated herein.

Referring now to FIGS. 3, 5 and 6, the brake pad pin 18 will now be discussed in more detail. The brake pad pin 18 is basically provided for mounting to the caliper housing 12 and for slidably supporting the brake pads 14 and the biasing member 16 within the brake rotor receiving slot 22 of the caliper housing 12. The brake pad pin 18 is disposed in the first and second pin receiving openings 40 and 42 of the caliper housing 12 with the thermally insulating materials 44 and 46 disposed between the brake pad pin 18 and the inner surfaces defining the first and second pin receiving openings 40 and 42, respectively. With this arrangement, the transfer of heat from the brake pads 14 via the brake pad pin 18 to the caliper housing 12 is suppressed by the thermally insulating materials 44 and 46. However, as explained below, the brake pad pin 18 is also configured to suppress the heat transfer from the brake pads 14 to the caliper housing 12 via the brake pad pin 18. Thus, with this arrangement, the transfer of heat from the brake pads 14 to the caliper housing 12 is suppressed by the thermally insulating materials 56 of the brake pads 14.

The brake pad pin 18 basically comprises an elongated support 60 and a thermally insulating material 62. The elongated support 60 includes a head portion 60a and an elongated rod portion 60b. The elongated support 60 is a one-piece, unitary member made of a suitable rigid material such as aluminum. The head portion 60a has a tool receiving recess (i.e., a slot) for receiving a tool. The elongated rod portion 60b of the elongated support 60 has an outer peripheral surface that is coated with thermally insulating material 62. The thermally insulating material 62 is made of a resin material such as an epoxy resin. The thermally insulating material 62 is fixedly attached to the outer peripheral surface of the elongated rod portion 60b of the elongated support 60. Thus, the thermally insulating material 62 is a tubular member that is provided with an annular clip retaining groove 62a. The brake pad pin 18 is retained to the caliper housing 12 with a spring clip 64 that is disposed in the clip retaining groove 62a of the thermally insulating material 62. With this arrangement, the transfer of heat from the brake pads 14 to the caliper housing 12 is suppressed by the thermally insulating material 62.

The thermally insulating materials 44, 46, 56 and 62 have a lower thermal conductivity than the material of the mounting plate 50 to suppress heat transfer along a route from the brake pads 14 to the caliper housing 12. For example, here, the mounting plate 50 is made of a stainless steel, which has a thermal conductivity in the range of 16 to 24 (W m⁻¹ K⁻¹)@25° C., and the thermally insulating materials 44, 46, 56 and 62 is made of a thermoset epoxy resin, which has a thermal conductivity in the range about 0.35 (W m⁻¹ K⁻¹)@25° C. Preferably, the thermally insulating materials 44, 46, 56 and 62 have a thermal conductivity of less than two-thirds of the thermal conductivity of the material of the mounting plate 50. More preferably, the thermally insulating materials 44, 46, 56 and 62 have a thermal conductivity of less than one-third of the thermal conductivity of the material of the mounting plate 50. Even more preferably, the thermally insulating materials 44, 46, 56 and 62 have a thermal conductivity of less than 1.0 (W m⁻¹ K⁻¹)@25° C. The thermally insulating materials 44, 46, 56 and 62 can be attached in a variety of ways, including, but not limited to, being laminated onto its respective parts, being molded onto its respective parts, and being formed as a separate member that is bonded to its respective parts.

Also while the thermally insulating materials 44, 46, 56 and 62 have all been incorporated into the disc brake caliper 10, it will be apparent that each of the thermally insulating materials 44, 46, 56 and 62 can be used alone and/or in any combination thereof. For example, the thermally insulating material 44 and/or 46 can be disposed one or both of the first and second pin receiving openings 40 and 42 of the caliper housing 12 without using the thermally insulating materials 56 and 62. Alternatively, one or both of the pin mounting openings 54 of the brake pads 14 can include the thermally insulating material 56 without using the thermally insulating materials 44, 46 and 62.

In another modification, the thermally insulating material 62 that is attached to an outer peripheral surface of the disc brake pad pin 18 can be formed only along the portions of the disc brake pad pin 18 that is disposed within the first pin receiving openings 40 and 42 of the caliper housing 12. More preferable, the thermally insulating material 62 has an axial length which is longer than an axial length of the pin receiving openings 40 and 42 of the caliper housing 12 and the pin mounting openings 54 of the brake pads 14.

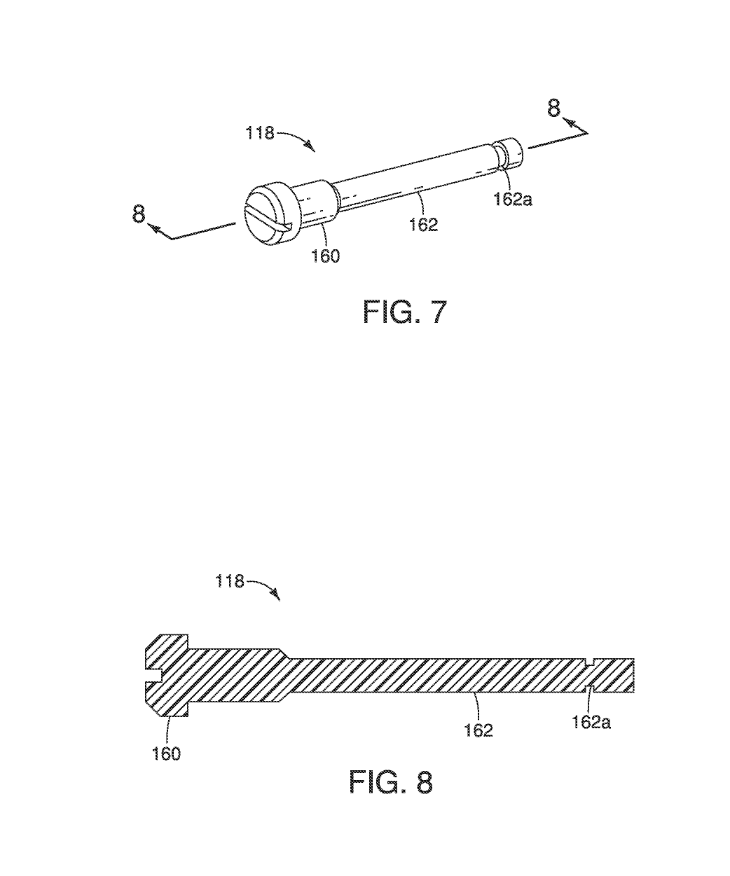

Referring to FIGS. 7 and 8, a modified disc brake pad pin 118 will now be discussed. Basically, the overall shape of the disc brake pad pin 118 is the same as the disc brake pad pin 18. However, in this modification, the disc brake pad pin 118 has a head portion 160 and an elongated rod portion 162, which are both made of a thermally insulating material. Preferably, as illustrated, the head portion 160 and the elongated rod portion 162 are integrally formed as a one-piece, unitary member. The elongated rod portion 162 is provided with an annular clip retaining groove 162a for receiving the spring clip 64.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. Also it will be understood that although the terms “first” and “second” may be used herein to describe various components these components should not be limited by these terms. These terms are only used to distinguish one component from another. Thus, for example, a first component discussed above could be termed a second component and vice-a-versa without departing from the teachings of the present invention.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired so long as they do not substantially their intended function. Components that are shown directly connected or contacting each other can have intermediate structures disposed between them unless specifically stated otherwise. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A disc brake caliper comprising:
a caliper housing defining a brake rotor receiving slot, and a first pin receiving opening;
a disc brake pad pin disposed in the first pin receiving opening;
at least one disc brake pad disposed in the brake rotor receiving slot and movably supported on the disc brake pad pin which extends through a pin mounting opening in the at least one disc brake pad; and
a thermally insulating material being disposed in at least one of the first pin receiving opening of the caliper housing and the pin mounting opening of the at least one disc brake pad.

2. The disc brake caliper according to claim 1, wherein
the thermally insulating material is attached to an outer peripheral surface of the disc brake pad pin at along a portion of the disc brake pad pin that is disposed within the first pin receiving opening of the caliper housing.

3. The disc brake caliper according to claim 2, wherein
the thermally insulating material has an axial length which is longer than an axial length of at least one of the first pin receiving opening of the caliper housing and the pin mounting opening of the at least one disc brake pad.

4. The disc brake caliper according to claim 2, wherein
the disc brake pad pin includes an elongated rod that defines the outer peripheral surface to which the thermally insulating material is attached.

5. The disc brake caliper according to claim 4, wherein
the caliper housing includes a second pin receiving opening, the elongated rod and the thermally insulating material are disposed in both of the first and second pin receiving openings.

6. The disc brake caliper according to claim 1, wherein
the thermally insulating material is attached to an inner surface defining the first receiving opening of the caliper housing.

7. The disc brake caliper according to claim 6, wherein
the caliper housing includes a second pin receiving opening, the thermally insulating material is further attached to an inner surface defining the second pin receiving opening of the caliper housing.

8. The disc brake caliper according to claim 1, wherein
the thermally insulating material is attached to an inner surface defining the pin mounting opening of the at least one disc brake pad.

9. The disc brake caliper according to claim 1, wherein
the thermally insulating material is made of a resin material.

10. A disc brake pad comprising:
a mounting plate having a pin mounting opening;
a friction pad fixedly attached to the mounting plate; and
a thermally insulating material attached to an inner surface defining the pin mounting opening.

11. A disc brake pad pin for supporting a disc brake pad comprising:
an elongated support having an outer peripheral surface; and
a thermally insulating material attached to the outer peripheral surface of the elongated support.

12. A disc brake pad pin tar supporting a disc brake pad comprising:
a head portion; and
an elongated rod portion made of a thermally insulating material.

13. The disc brake pad pin according to claim 12, wherein
the head portion is also made of a thermally insulating material.

14. A disc brake caliper housing comprising:
a caliper housing defining a first pin receiving opening; and
a thermally insulating material attached to an inner surface defining the first pin receiving opening.
